(19) United States
(12) Patent Application Publication
(10) Pub. No.: US 2017/0001049 A1
(43) Pub. Date: Jan. 5, 2017

(54) Outerwear Garment For Use With A Fall-Arrest Harness

(71) Applicant: Pete Zeppetella, St. Catharines (CA)

(72) Inventor: Pete Zeppetella, St. Catharines (CA)

(21) Appl. No.: 14/685,022

(22) Filed: Apr. 13, 2015

(51) Int. Cl. A62B 35/00

(52) U.S. Cl. CPC A62B 35/0006; A62B 35/0037

(57) ABSTRACT

An outerwear garment for use with a fall-arrest harness devised to permit a fall-arrest harness to be worn underneath an outerwear garment body, such as a jacket, vest, or coat, between an aperture on a rear side thereof and a Dee-ring access flap covering the aperture. A plurality of releasably engageable two-part fasteners disposed on each of the rear side adjacent the access flap and along the perimeter of the access flap permits the access flap to be automatically opened for access to the fall-arrest harness. Lanyard hook-receiving members disposed on a front side of the garment body also permit hanging of lanyard hooks thereon during periods of non-use.

### CROSS-REFERENCE TO RELATED APPLICATIONS

Not Applicable

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### BACKGROUND OF THE INVENTION

Various types of safety body garments are known in the prior art. However, what is needed is an outerwear garment for use with a fall-arrest harness including a rear side Dee-ring access flap which permits the fall-arrest harness to be worn underneath the outerwear garment and then exposed for safe attachment to an anchor of a personal fall-arrest system to arrest a wearer in a fall from a working level.

### FIELD OF THE INVENTION

The present invention relates to safety body garments, and more particularly, to an outerwear garment for use with a fall-arrest harness that includes a quick-release Dee-ring access flap on a rear side of the outerwear garment that normally covers the fall-arrest harness until needed for use.

### SUMMARY OF THE INVENTION

The general purpose of the present outerwear garment for use with a fall-arrest harness, described subsequently in greater detail, is to provide an outerwear garment for use with a fall-arrest harness which has many novel features that result in an outerwear garment which is safe to use with a fall-arrest harness which is not anticipated, rendered obvious, suggested, or even implied by prior art, either alone or in combination thereof.

To accomplish this, the present outerwear garment for use with a fall-arrest harness is devised to improve workplace safety by eliminating the practice of wearing a traditional fall-arrest harness over an outerwear garment, such as a jacket or vest. This practice is often associated with workers failing to wear their harnesses in a properly fastened state at all times while on the job as workers often fail to sufficiently tighten fall-arrest harnesses over such garments, leading to potential injuries or death should a fall event occur. In cases in which workers must frequently put on and take off such garments, the temptation to fail to properly wear and connect the harnesses is present. If the harness is worn over bulky clothing, as needed during cold weather, the harness restricts movement and prevents the harness from properly working. If a worker wears a harness under an outerwear garment, the movement of the lanyard is restricted. In the event of a fall, the force on the lanyard and angle of the lanyard and harness can result in outwear garment choking or wrenching the body of the worker. The present device addresses the foregoing problems by providing an outerwear garment body with an aperture in the rear side thereof and Dee-ring access flap that covers the aperture. A plurality of releasably engageable two-part fasteners is disposed on each of the rear side adjacent the Dee-ring access flap and along the perimeter of the Dee-ring access flap to permit the Dee-ring access flap to be automatically opened. The access flap includes an inverted right-trapezoidal upper portion and a rectangular lower portion. A plurality of lanyard hook-receiving members is disposed on the front side of the garment body to provide a means for hanging the lanyard hooks during periods of non-use to prevent the harness from being damaged such as, for example, by being dragged on the ground. The present device allows the wearer to properly wear the fall-arrest harness while wearing an outerwear garment without impeding proper use of the fall-arrest harness and without restricting movement of the lanyard, thus relieving the impact of any force the outerwear garment could otherwise have had on the wearer.

Thus has been broadly outlined the more important features of the present outerwear garment for use with a fall-arrest harness so that the detailed description thereof that follows may be better understood and in order that the present contribution to the art may be better appreciated.

### BRIEF DESCRIPTION OF THE DRAWINGS

### Figures

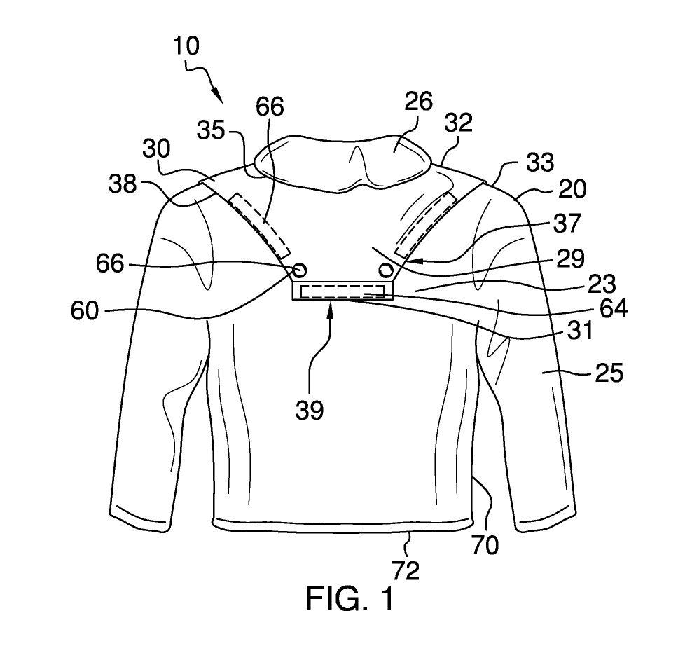

FIG. 1 is a rear elevation view showing a Dee-ring access flap in a closed position.

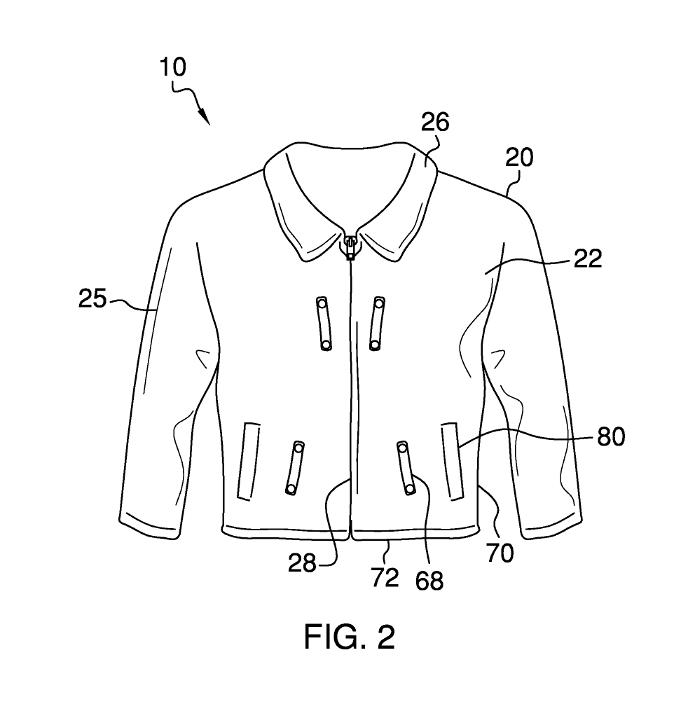

FIG. 2 is a front elevation view.

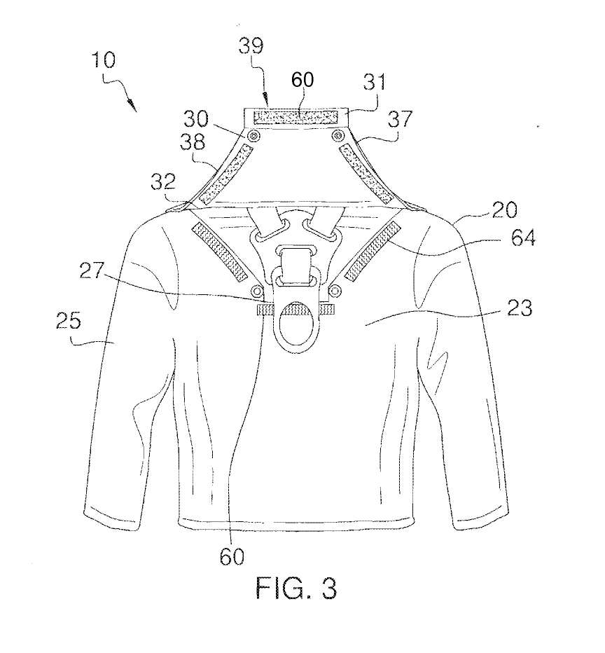

FIG. 3 is a rear elevation view showing the access flap in an open condition.

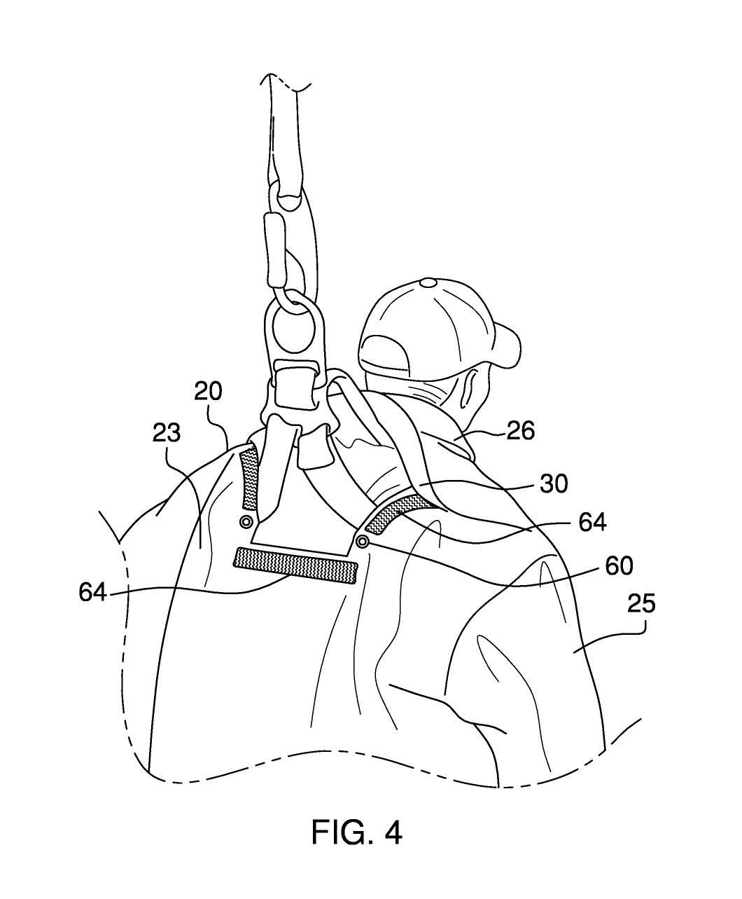

FIG. 4 is an in-use rear elevation view showing the access flap in an open condition and a fall-arrest harness extended with the Dee-ring attached to a lanyard.

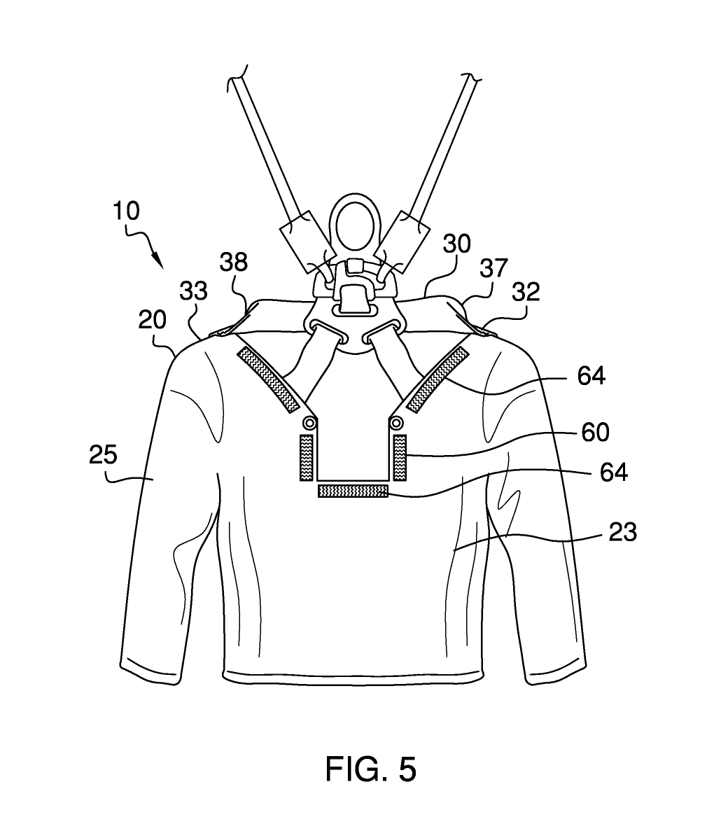

FIG. 5 is a rear elevation view showing the fall-arrest harness completely extended and the access flap in an open condition.

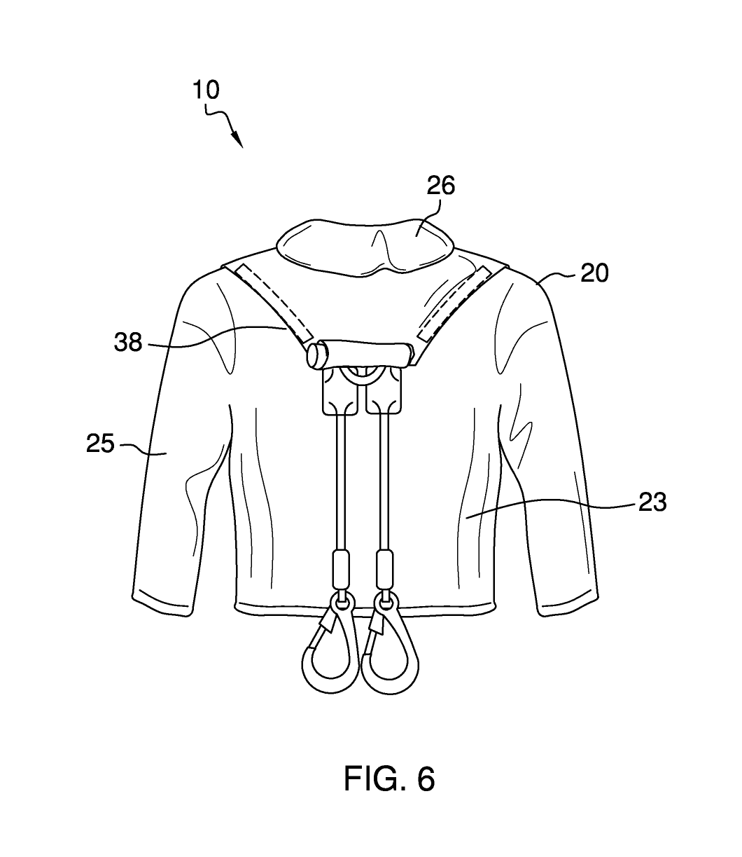

FIG. 6 is an in-use rear elevation view showing the access flap in a partially open condition showing a pair of lanyard hooks of a retractable lanyard fall-arrest harness extending out of the access flap.

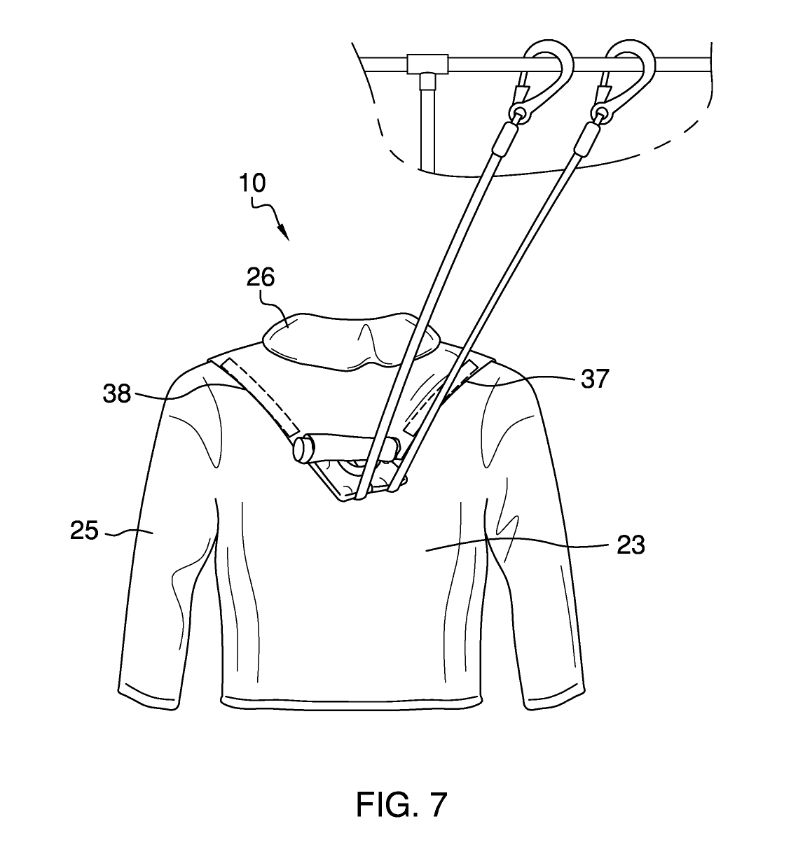

FIG. 7 is an in-use rear elevation view showing the access flap in a substantially closed position with the reels and straps of a retractable lanyard of the fall-arrest harness extending out of the access flap having a lanyard hook on the end of each lanyard attached to an anchoring member.

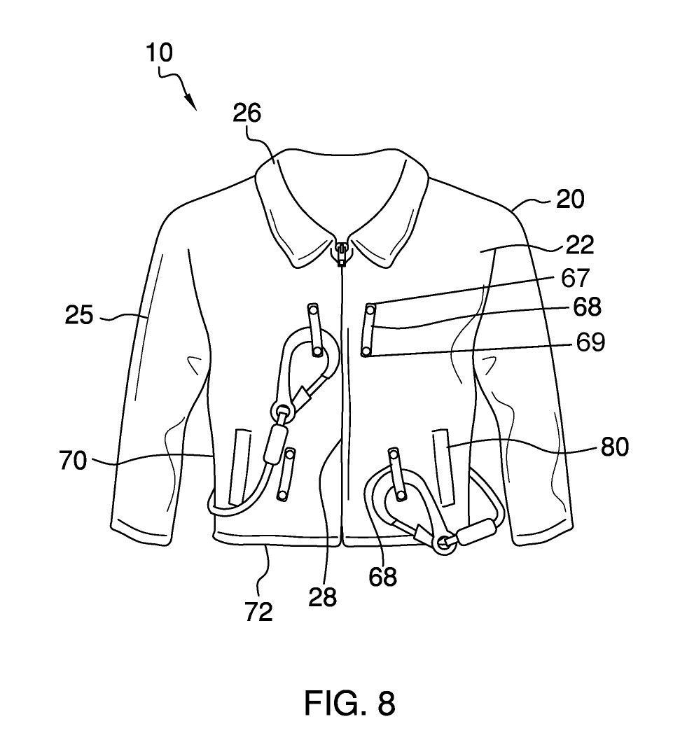

FIG. 8 is an in-use front elevation view showing a lanyard hook attached to each of a pair of lanyard hook-receiving members on a front side of an outerwear garment body when the lanyard hooks are not being used for fall-arrest of the wearer.

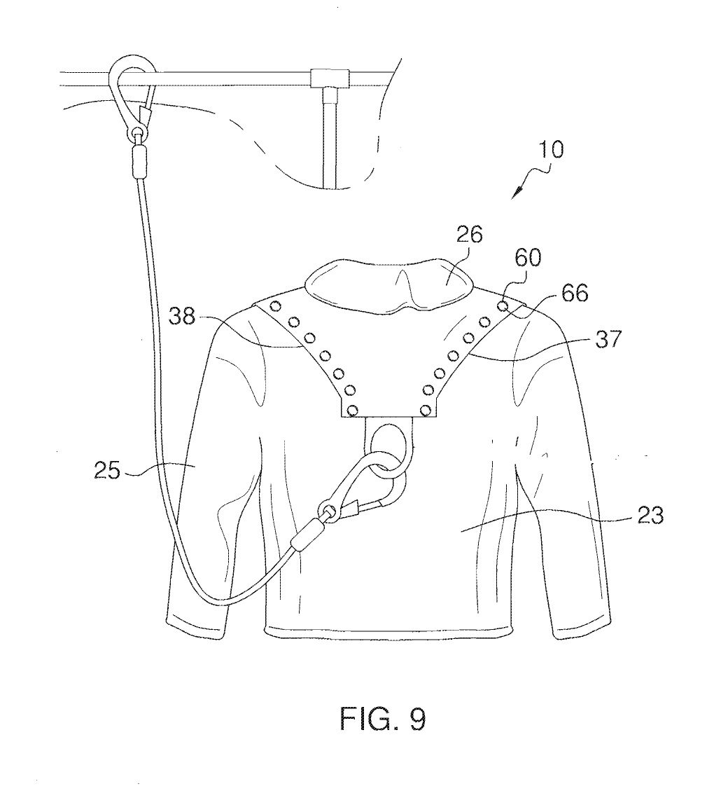

FIG. 9 is a rear elevation view showing a plurality of fasteners in the form of snap fasteners disposed along the access flap.

### DETAILED DESCRIPTION OF THE DRAWINGS

With reference now to the drawings, and in particular FIGS. 1 through 9 thereof, an example of the instant outerwear garment for use with a fall-arrest harness employing the principles and concepts of the present outerwear garment for use with a fall-arrest harness and generally designated by the reference number 10 will be described. The present device 10 is devised to eliminate the practice of having to wear a traditional fall-arrest harness over an outerwear garment, but instead to enable a traditional fall-arrest harness to be worn underneath the outerwear garment, thus increasing workplace safety.

Referring to FIGS. 1 through 9, the present outerwear garment for use with a fall-arrest harness 10 is illustrated. The outerwear garment for use with a fall-arrest harness 10 includes an outerwear garment body 20, such as a jacket, a rain coat, a vest, or a winter coat. The garment body 20 has at least a front side 22 and a rear side 23. The garment body 20, as shown in the drawings, may also include any one or a combination of a front closure 28, such as a zipper or at least one button, centrally disposed along a vertical midline axis of the front side 22, a pair of sleeves 25, and a collar 26. The outerwear garment body 20, in the form of a vest, would generally not include the sleeves 25 and may or may not include a collar 26. An aperture 27 is disposed on the rear side 23.

A Dee-ring access flap 29 is disposed on the rear side 23 to cover the aperture 27. A fall-arrest harness is worn prior to use between the access flap 29 and an item of clothing worn by a user to cover the user's upper torso. The access flap 29 has a right-trapezoidal upper portion 30 disposed in an inverted position on the rear side 23 and a rectangular lower portion 31 conjoined to the upper portion 30. The upper portion 30 has an upper side 32 that continuously extends along each of a shoulder seam 33 of the garment body 20 as well as a rear portion 35 of collar 26. The access flap 29 has a right side 37, a left side 38, and a lower side 39. The lower side 39 is shorter than the upper side 32 and is centered on the rear side 23 of the outerwear garment body 20. The access flap 29 has surface area configured to cover a fall-arrest harness disposed between the access flap 29 and an item of clothing worn, such as a shirt, by a user to cover the user's upper torso. The aperture 27 has the same configuration as the access flap 29.

The term fall-arrest harness as used herein is a harness secured to a wearer to distribute the fall-arrest forces over various parts of the wearer's body with means for attaching the fall-arrest harness to anchoring components of a personal fall-arrest system to arrest the wearer in a fall from a working level.

A plurality of two-part fasteners 60, configured to disengage and provide the automatic opening of the access flap 29 when a lanyard of a fall-arrest harness is pulled upwardly, is disposed directly on each of the access flap 29 and the outerwear garment body 20 rear side 23 directly adjacent the right side 37, the left side 38, and the lower side 39 of the access flap 29. Each fastener 60 is one of a hook and loop fastener 64 and a snap fastener 66. The opening of the access flap 29 permits access to, exposure, and use of the Dee-ring of the fall-arrest harness worn underneath the garment body 20, for anchoring the wearer to an anchor point to prevent falling from the precarious situation. The fasteners 60 permit the access flap 29 to open for use of the fall-arrest harness without pulling the garment body 20 out of position when the wearer slips and is caught by the fall-arrest harness. The access flap 30 also permits the outerwear garment body to be reused.

A plurality of lanyard hook-receiving members 68 is disposed on the front side 22 of the outerwear garment body 20. As shown in FIG. 2, one pair of the lanyard hook-receiving members 68 is disposed proximal the front closure 28, while another pair of the lanyard hook-receiving members 68 is disposed approximately midway between the front closure 28 and each of a side seam 70 of the outerwear garment body 20 proximal a bottom edge 72 of the garment body 20. The lanyard hook-receiving members 68 provide a means for hanging the lanyard hooks thereon during periods of non-use to prevent the fall-arrest harness from being damaged such as, for example, by being dragged on the ground. The outerwear garment body 20 can also include a plurality of pockets 80.

1. An outerwear garment for use with a fall-arrest harness comprising:
an outerwear garment body having at least a front side and a rear side;
a Dee-ring access flap disposed on the rear side of the garment body, the access flap having an upper side continuously extending along each of a shoulder seam of the garment body and a rear portion of a collar, the access flap further having a right side, a left side, and a lower side;
an aperture disposed on the rear side, the aperture having a same configuration as a configuration of the access flap, wherein the access flap is configured to cover only the entire aperture, a portion of the fall-arrest harness disposed directly underneath the aperture and a Dee-ring of the fall-arrest harness disposed directly underneath the aperture when the fall-arrest harness is being worn underneath the garment body and the access flap is in a fastened condition, the shoulder seam of the garment body when the access flap is in the fastened condition, and the rear portion of the collar and portions of the garment body directly adjacent to the shoulder seam and the rear portion of the collar when the access flap is in the fastened condition;
a plurality of two-part fasteners disposed directly on each of the right side, the left side, and the lower side of the access flap and the garment body rear side directly adjacent the right side, the left side, and the lower side of the access flap, the fasteners being configured to automatically disengage and release the access flap from the outerwear garment body when a lanyard of a fall-arrest harness is pulled upwardly;
wherein the access flap has surface area, wherein the surface area of the access flap is configured to cover a fall-arrest harness disposed between the access flap and an item of clothing worn by a user to cover the user's upper torso.

2. The outerwear garment for use with a fall-arrest harness of claim 1 further comprising a plurality of rectangular lanyard hook-receiving members disposed on the front side of the garment body, each of the plurality of lanyard hook-receiving members having an upper end attached to the outerwear garment body and a lower end attached to the outerwear garment body.

3. The outerwear garment for use with a fall-arrest harness of claim 1 further comprising a front closure centrally disposed along a vertical midline axis of the front side.

4. The outerwear garment for use with fall-arrest harness of claim 1 further comprising a plurality of pockets.

5. The outerwear garment for use with a fall-arrest harness of claim 2 further comprising a front closure centrally disposed along a vertical midline axis of the front side.

6. The outerwear garment for use with fall-arrest harness of claim 2 further comprising a plurality of pockets.

7. The outerwear garment for use with fall-arrest harness of claim 3 further comprising a plurality of pockets.

8. The outerwear garment for use with a fall-arrest harness of claim 5 wherein a first pair of the lanyard hook-receiving members is disposed proximal the front closure and a second pair of the lanyard hook-receiving members is disposed approximately midway between the front closure and each of a side seam of the garment body proximal a bottom edge of the garment body.

9. An outerwear garment for use with a fall-arrest harness comprising:
an outerwear garment body having a front side, a rear side, a pair of sleeves, a collar, and a front closure centrally disposed along a vertical midline axis of the front side;
a right-trapezoidal Dee-ring access flap disposed in an inverted position on the rear side of the garment body, the access flap having an upper side continuously extending along each of a shoulder seam of the garment body and a rear portion of a collar, the access flap further having a right side, a left side, and a lower side, the lower side being shorter than the upper side and centered on the rear side of the garment body;
an aperture disposed on the rear side, the aperture having a same configuration as a configuration of the access flap, wherein the access flap is configured to cover only the entire aperture, a portion of the fall-arrest harness disposed directly underneath the aperture and a Dee-ring of the fall-arrest harness disposed directly underneath the aperture when the fall-arrest harness is being worn underneath the garment body and the access flap is in a fastened condition, the shoulder seam of the garment body when the access flap is in the fastened condition, and the rear portion of the collar and portions of the garment body directly adjacent to the shoulder seam and the rear portion of the collar when the access flap is in the fastened condition;
a plurality of two-part fasteners disposed directly on each of the right side, the left side, and the lower side of the access flap and the garment body rear side directly adjacent the right side, the left side, and the lower side of the access flap, the fasteners being configured to automatically disengage and release the access flap from the outerwear garment body when a lanyard of a fall-arrest harness is pulled upwardly;
a plurality of rectangular lanyard hook-receiving members disposed on the front side of the garment body, each of the plurality of lanyard hook-receiving members having an upper end attached to the outerwear garment body and a lower end attached to the outerwear garment body, wherein a first pair of the lanyard hook-receiving members is disposed proximal the front closure and a second pair of the lanyard hook-receiving members is disposed approximately midway between the front closure and each of a side seam of the garment body proximal a bottom edge of the garment body; and
a plurality of pockets, wherein at least a pair of the pockets is disposed on the front side in a vertical position parallel to the second pair of lanyard hook-receiving members and more proximal the garment body side seams than the lanyard hook-receiving members;
wherein the access flap has surface area, wherein the surface area of the access flap is configured to cover a fall-arrest harness disposed between the access flap and an item of clothing worn by a user to cover the user's upper torso.

10. The outerwear garment for use with a fall-arrest harness of claim 9 wherein each two-part fastener is one of a hook and loop fastener, and a snap fastener.
